(19) United States
(12) Patent Application Publication
(10) Pub. No.: US 2005/0170779 A1
(43) Pub. Date: Aug. 4, 2005

(54) Power monitoring circuitry for wireless fidelity (WiFi)

(76) Inventors: Greg Tangonan, Oxnard, CA (US); Carlos M. Oppus, Marikina City (PH); Jose Claro Monje, Santa Rosa (PH); Joel Joseph Marciano JR., Quezon City (PH)

Correspondence Address: TOPE-MCKAY & ASSOCIATES, 23852 PACIFIC COAST HIGHWAY #311, MALIBU, CA, 90265, US

(21) Appl. No.: 10/967,108

(22) Filed: Oct. 14, 2004

Related U.S. Application Data
(60) Provisional application No. 60/510,779, filed on Oct. 14, 2003.

(51) Int. Cl. H04B 7/00; H04B 1/06

(52) U.S. Cl. 455/66.1; 455/41.2

(57) ABSTRACT

The present invention relates to a power monitoring circuit for use in wireless fidelity (WiFi) systems. More specifically, the invention is a low power, inexpensive radio frequency (RF) power monitoring circuit that incorporates the integrated circuit for amplification, analog-to-digital conversion, and antenna circuit into a single simple circuit.

### PRIORITY CLAIM

The present application claims the benefit of priority of U.S. Provisional Patent Application No. 60/510,779, filed Oct. 14, 2003, entitled “Power Monitoring Circuitry for Wireless Fidelity (WiFi) Applications.”

### BACKGROUND OF THE INVENTION

(1) Technical Field

The present invention relates to power monitoring circuitry, in particular to the small radio frequency power monitoring circuits for use in wireless fidelity (WiFi) systems.

(2) Background

Deployment of Wireless Fidelity (WiFi) circuits in campus, commercial and enterprise networks is proceeding rapidly; in fact, this is perhaps the major boom within the wireless industry today. The WiFi industry is branching out to include home electronics as a very promising new business. With WiFi in appliances the network can be connected to televisions and monitors for video streaming in the home. Video sharing and security systems over WiFi will bring new communications capability to computers and home communications equipment. This invention describes the use of power monitoring devices within the context of these applications as being crucial to commercial success.

### SUMMARY OF THE INVENTION

The present invention relates to a power monitoring circuit for use in wireless fidelity (WiFi) systems. More specifically, the invention is a low power, inexpensive radio frequency (RF) power monitoring circuit that incorporates the integrated circuit for amplification, analog-to-digital conversion, and antenna circuit into a single simple circuit.

### BRIEF DESCRIPTION OF THE DRAWINGS

The objects, features and advantages of the present invention will be apparent from the following detailed descriptions of the preferred aspect of the invention in conjunction with reference to the following drawings, where:

FIG. 1 depicts an integrated radio frequency (RF) detector circuit for detecting, processing and displaying the strength of a wireless signal in a particular band.

FIG. 2 depicts a multi-band measurement system incorporates two resonant antennas formed into a three-dimensional arrangement by folding a board along a line.

FIG. 3 depicts a switchable filter incorporating RF MEMS switches.

FIG. 4 depicts the potential applications of RF power indicators in various devices.

FIG. 5 depicts a schematic of an RF power circuit placed within a common memory stick.

### DETAILED DESCRIPTION

The present invention relates to a power monitoring circuit for use in wireless fidelity (WiFi) systems. More specifically, the invention is a low power, inexpensive radio frequency (RF) power monitoring circuit that incorporates the integrated circuit for amplification, analog-to-digital conversion, and antenna circuit into a single simple circuit. The following description, taken in conjunction with the referenced drawings, is presented to enable one of ordinary skill in the art to make and use the invention and to incorporate it in the context of particular applications. Various modifications, as well as a variety of uses in different applications, will be readily apparent to those skilled in the art, and the general principles, defined herein, may be applied to a wide range of embodiments. Thus, the present invention is not intended to be limited to the embodiments presented, but is to be accorded the widest scope consistent with the principles and novel features disclosed herein. Furthermore, it should be noted that unless explicitly stated otherwise, the figures included herein are illustrated diagrammatically and without any specific scale, as they are provided as qualitative illustrations of the concept of the present invention.

(1) Introduction

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

(2) Details

This invention deals with small, inexpensive radio frequency (RF) power monitoring circuits and their use within the wireless fidelity (WiFi) systems. We describe the integrated RF power measuring circuits that incorporates the integrated circuit for amplification, analog-to-digital conversion, and antenna circuit into a single simple circuit. The detector circuit can be made placed within WiFi systems to unique purposes that are described herein.

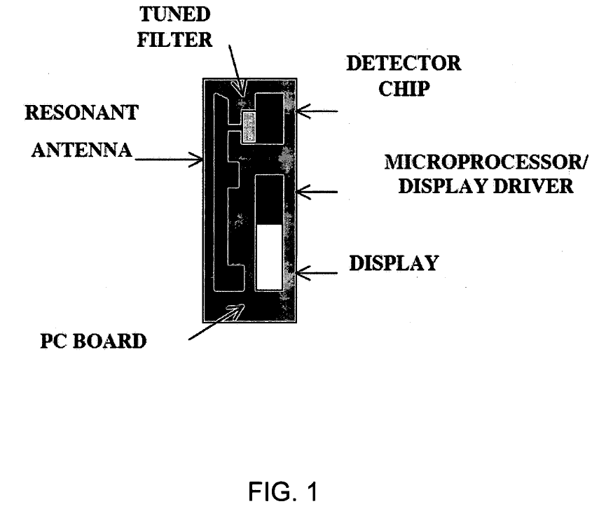

The complete RF detector circuit includes the antenna, RF detector chip, microprocessor, display driver and display as shown in FIG. 1. With the emergence of low cost surface mount circuits for amplifications and analog-to-digital (A/D) conversion, this design is made much simpler and more cost effective. The resonant antenna shown in FIG. 1 is tuned to a particular band (WiFi band, for instance). The antenna circuit may contain a filter, as shown, that is tunable to a particular band. The antenna can also be highly resonant at the operating frequency and operate without filters. The detector chip is a commercial device that detects the RF signal at its input, amplifies the signal (logarithmically for high dynamic range), and converts the signal to a digital output. A microprocessor receives the input from the detector and prepares the data for display. The microprocessor serves several functions in our design in that it can perform the following functions: tune the filter to a particular band of interest, sets the threshold for on/off detection, and sets the display mode for the particular application. Lastly a display is incorporated into to inform the user of the nature of the RF signal (signal strength, operating band, WiFi mode (802.11a, b, and g), channel number, and coding type). To minimize rapid fluctuations in the display: we match the dynamic range of the receiver to the required application, apply simple threshold techniques for simple “OK” or “NOT OK” indication, and averaging of several measurements. The integrated system therefore is adaptable to meet the needs of various uses without increasing cost, since the basic design meets simple to more demanding needs.

It is important to make this unit as small as possible so that it can be incorporated in many applications. In this sense our invention differs significantly from other proposals in that the unit is designed as an integrated antenna circuit, since it is the antenna that demands physical size for efficient performance. The board design therefore requires compact antenna designs that produce strong resonant response like the inverted RF antenna shown. One particularly attractive approach for the board design is to use a tri-layer board with a ground plane in the middle. The digital processing and analog chips are placed on the top layer and the planar antenna is placed on the bottom board. Two layer designs are also practicable with the ground plane being common for both the antenna and the circuits. The board however does not necessarily have to be flat, and in fact, there are performance advantages to a three dimensional (3-D) design. For several applications the arrangement can be in three dimensions to accommodate more compact placement. Of critical importance therefore is providing enough ground plane for efficient reception gain of the antenna.

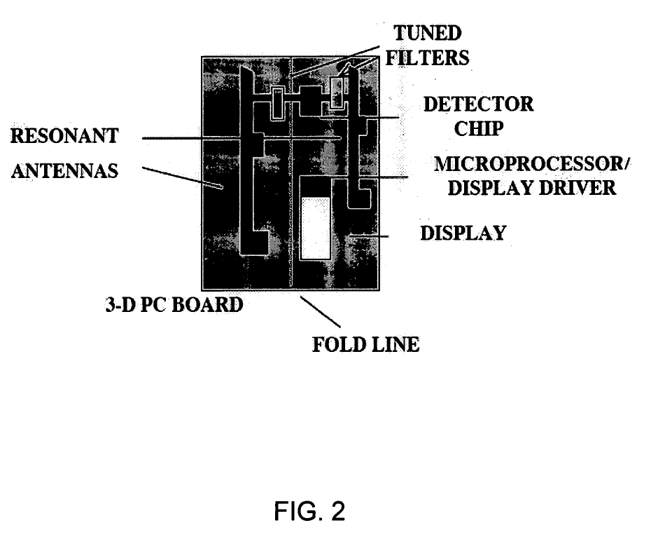

Shown in FIG. 2 is a new embodiment that uses the 3-D arrangement for multiple frequency use. In this design two resonant antennas are used to cover several frequencies. These are antenna designs that can have multiple resonances. The broadband detector serves both bands and a bank of switchable or tunable filters removes unwanted signals. The board is folded at the fold line. The antennas are designed to make use of the extra-parasitic capacitances of the whole system for proper reception. There is greater advantage in using this 3-D arrangement for optimizing the resonant conditions for the individual antennas. This is the first implementation of these new design techniques to multi-band power monitoring circuits. Careful modeling and testing can determine the optimum layout for the antennas and ground planes. In addition this approach can lead to reconfigurable antennas when parasitic elements are switched in and out of vicinity of the antenna element. These structures are not shown in the Figure but can be easily formed as patches with RF micro-electromechanical system (MEMS) selector switches. Lastly the layout can be designed to performance polarization diversity reception as well, something that will be very important in mobile wireless applications.

FIG. 2 depicts the multi-band measurement system incorporates two resonant antennas formed into a three-dimensional arrangement by folding the board along the line. In this design the different bands are sensed by the antennas and the microprocessor, display driver and display are common. The antenna layout is optimized to incorporate the effects of the folded metal ground plane into its resonant response.

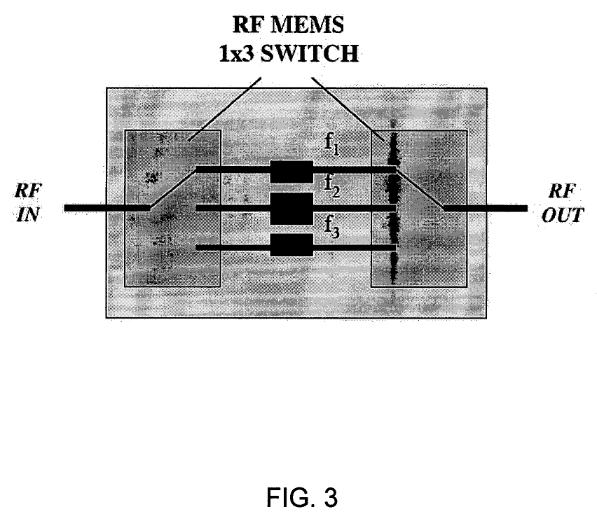

The RF filter circuits for selecting the different signals incorporate new technologies to optimum advantage. Our preferred embodiment includes RF MEMS switches because of their high isolation, low loss, and low power consumption. Shown in FIG. 3 is an arrangement of RF MEMS switches that selects from three frequencies within the broader antenna response.

FIG. 3 depicts the switchable filter that incorporates RF MEMS switches as the preferred embodiment because of the high isolation, low loss and low power consumption of these switch designs.

Packaged RF MEMS switch circuits are just now becoming available on the market. Because we envisage that these devices will necessarily be on for long period of time, low power requirements and latching switches are preferred. RF MEMS afford this new design of a power monitoring circuits with multiple advantages. The product applications that will require our new monitoring circuits are quite numerous but we must discuss several in detail because the new system provides unique advantages. We will discuss the application to WiFi appliances first. With the incorporation of WiFi into appliances like televisions and monitors, streaming video applications become possible.

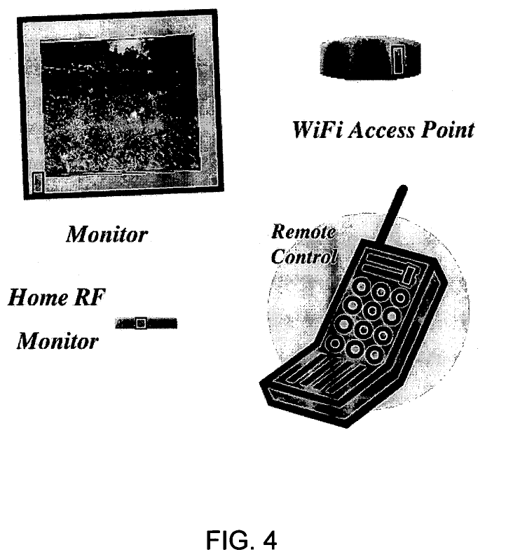

Shown in FIG. 4 is a typical home RF system incorporating a base station, television, home RF power monitor and a multi-function remote control. For proper operation of the system, our low cost RF detector circuit must be incorporated into the WiFi access point, television, home RF power monitor, and remote control. Consumers must be able to tell at a glance the system is WiFi enabled. Most access points on the market today do not provide a true power monitoring capability, one that indicates real power being transmitted. The indicators in the hand held controller, on the desk, or on the television indicate if WiFi is available for viewing email, streaming video, or multimedia presentations. In the streaming video application, it is anticipated that 802.11a will be used for high speed downloading, while for email displays or web browsing 802.11b might be used in most appliances. Thus multi-band RF power monitors with displays become a requirement for optimum user friendliness. Another embodiment of the Home RF monitoring unit is to incorporate the power measurement circuit with an existing circuit like a USB memory. This would make add a useful functionality into a common communications tools.

FIG. 4 depicts a home entertainment system using WiFi for streaming video require lost cost RF Power indicators for displaying “WiFi Ready” within the handheld remote control, on the monitor and from a Home RF Monitor.

In a similar situation to that of the Home RF systems, obtaining an indication of the presence of WiFi activity will be important. Whenever a person enters an area where WiFi is used for surveillance using WiFi Web cameras, an indicator should tell him of its use. With the emerging use of WiFi for RF tagging and Identification and the use of WiFi for sensing, one can use a simple power monitor to detect the use of WiFi for sensing. These circuits we have developed are easily added to existing communications devices like cell phones, memory sticks, and PDA's.

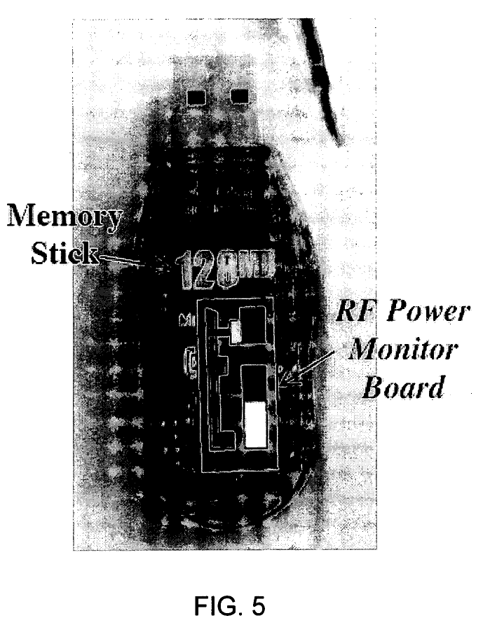

Shown in FIG. 5 is a schematic of our circuit placed within a memory stick. Powering the device can be achieved through the use of in device battery powering, USB powering, or solar cells.

FIG. 5 depicts a dual use application of a power monitoring circuit incorporated within a memory stick. The complete board is within the device and the display is an integral part of the user interface of the dual use product. With powering the device will indicate whenever the WiFi radiation is present and serve as a functioning memory device.

These applications indicate that detecting WiFi base stations will be given great impetus by the new design of low cost and small WiFi monitors described herein.

(3) Further Embodiment

In another embodiment, low cost receivers are practicable using existing low cost circuits available from commercial vendors in a novel way. In large quantities these circuits cost one dollar a piece. We first considered a high dynamic range detector circuit made by Analog Devices (Analog Devices, Norwood, Mass. 02062). The AD8362 model measures the root mean square and has a 60 decibels (dB) measurement range. It is intended for use in a variety of high frequency communication systems and in instrumentation requiring an accurate response to signal power. For use as an indicator of power sufficient to connect WiFi receivers, accuracy can be sacrificed for increased measurement range. So for a go-no-go indicator the chip can work far below its accuracy limit of −60 dBm, as measured by the manufacturer. For a go-no-go indicator, the chip can be used without an amplifier to the WiFi receiver sensitivity level of −75 dBm. This is key to achieving low cost power indicators—we have shown here that a highly sensitive indicator is readily achieved using these parts. Of course with an integrated log-amplifier this can be achieved at even lower levels with good sensitivity. A good example of this type of circuit is the Analog Device chip AD8316 which has a low error limit of performance of −65 dBm. As a go-no-go indicator this will work to the −80 dBm level.

We demonstrated a WiFi power detector using the AD8361 chip. The chip was soldered onto a PC board and interfaced with a monopole antenna. We successfully measured the multi-path variations of signals in the WiFi band. Using high dynamic range chips like the AD8362 will get us to the power levels desired.

The antenna choice for this experiment is a cheap monopole with very good gain. This can be replaced with a more highly resonant antenna that will eliminate the need for a WiFi band filter. However inexpensive filters are coming available for this purpose too. Our preferred approach is that using resonant antennas since this will lead to the lowest cost approach.

1. An integrated radio frequency (RF) detector circuit for detecting, processing and displaying the strength of wireless signal in a particular band.

2. An integrated RF detector circuit as in claim 1, wherein a de-multi-band measurement system incorporates several resonant antennas formed into a three-dimensional arrangement for compact design.

3. An integrated RF detector circuit as in claim 1, wherein the power measuring for multiple bands uses a tunable filter for band selection that incorporates RF micro-electromechanical systems (MEMS) switches for low loss, high isolation from noise and interference, and low power consumption.

4. An integrated RF detector circuit as in claim 1, further comprising a home RF power monitoring system for optimum user friendliness of WiFi based home entertainment as stand alone or incorporated elements of communications.

5. An integrated RF detector circuit as in claim 1, further comprising simple RF monitor detectors for sensing when WiFi is active for surveillance, sensing and monitoring, in addition to wireless data access.
